(19) United States
(12) Patent Application Publication
(10) Pub. No.: US 2003/0041243 A1
(43) Pub. Date: Feb. 27, 2003

(54) Security system against illegal use and copy of eletronic data

(76) Inventors: Nelson Eric Ramirez Olguin, Oslo (NO); Alexi Oviolio Ramirez Olguin, Oslo (NO)

Correspondence Address: Nelson Eric Ramirez Olguin, Dryretraakket 1, Oslo, 1251, NO

(21) Appl. No.: 10/220,574

(22) PCT Filed: Feb. 26, 2001
(86) PCT No.: PCT/NO01/00075

(30) Foreign Application Priority Data
Mar. 2, 2000 (NO) 2000/066

(51) Int. Cl. H04L 9/00

(52) U.S. Cl. 713/172

(57) ABSTRACT

The invention hereby presented is a security system against illegal use and/or copy of electronic data. This security system protects electronic data against being used and/or copied by users that have not purchased this right from the respective producer/provider.

The security system consists in four parts, namely; a computer program or any other form of electronic data that has to be protected (electronic data 9), a physical key containing key information (physical key 10), a component that generates the physical key (component 1) and a component that reads and updates the key information in the physical key (component 11).

The minimum information the physical key should contain is am identity that identifies the physical key (identity 3), a counter that registers the number of time the protected electronic data is installed (counter 4) and a link to the electronic data to be protected (application identity 5). In addition, the physical dey can also contain a limit value that establishes the limit to the maxim;um number a protected electronic data can be installed (limit value 6). If this limit value is not contained by the physical key, the limit value has to be contained by the electronic data to be portected of by the respective installation program.

When the electronic data is installed, the physical key has to be in place for the process to be carried out. The counter in the physical key is then compared with the limit value. If the counter in less than the limit value, the electronic data is installed and the counter updated (counter=counter+1). When the uninstallation process is started, the physical key has also to be in place. In this case, the counter is reduced (counter=counter−1).

The physical key loses its functionality if the key information it contains is manually changed. Copies of the physical key are not functional.

### 1.1 BACKGROUND AND AREA OF APPLICATION

The invention hereby presented is a security system against illegal use and/or copy of electronic data. This system will protect electronic data from being utilised and/or copied by users that have not bought this right from the respective producer/provider.

During the last years, electronic data (software or any other form of electronic data) has become extensively available in the global market via traditional distribution channels, Internet. etc. In general, electronic data is protected by copyright lows in almost any country. However, this is unfortunately not enough to stop the illegal use and copy of electronic data by non-authorised users. In today's society, a diversity of copying methods (disk, CD-writer, ZIP-driver, etc.) are easy available to the general public. This makes it quite simple for non-authorised users to copy, utilise or have access to illegal copies of electronic data. Consequently, producers and/or providers of electronic data suffer large economic losses in the form of unrealised sales. Therefore, it is necessary to develop a security system for protecting electronic data (software or any other form of electronic data) against illegal copy and use besides existing copyright lows. The invention hereby presented is intended to solve this problem in an effective, efficient and easy manner.

### 1.2 STATUS QUO

After a relative extensive literature research, it appears that it exists different attempts by a series of inventors to solve the problem addressed by the present invention. The attempts stretch from the 70's to the 90's and vary in effectiveness and practical application. These suffer from different weaknesses; software can only be installed in a predefined computer (U.S. Pat. No. 4,866,769, U.S. Pat. No. 4,748,561, U.S. Pat. No. 4,796,220), software can only be run if a given storage medium which cannot be copied is present (U.S. Pat. No. 4,577,289, U.S. Pat. No. 5,615,061, U.S. Pat. No. 4,458,315), additional devices are required installed in the user's computer (U.S. Pat. No. 4,120,030, U.S. Pat. No. 4,817,140, U.S. Pat. No. 5,109,413, U.S. Pat. No. 4,634,807, U.S. Pat. No. 4,446,519, U.S. Pat. No. 5,182,770), new computer systems are required (U.S. Pat. No. 4,558,176), the security system consists of a storage medium that cannot be copied, but that allows an unlimited number of installations (U.S. Pat. No. 4,658,093), software can only be utilised a pre-defined number of times (U.S. Pat. No. 4,658,093), the security system required a server/client configuration (U.S. Pat. No. 5,754,864).

There are three inventions that have come quite near to solve this problem, namely U.S. Pat. No. 5,199,066, U.S. Pat. No. 5,796,824 and U.S. Pat. No. 6,006,190. The first (U.S. Pat. No. 5,199,066) consists in that when installing software, a temporary code is generated based on hardware specific information and on a code specific to the software (first software code). The temporary code is then combined with an activation code supplied by the producer. The combination of these two codes generates again a secondary code, which is compared with a hidden number (specific to the software that is being installed—second software code). Only if these two last codes are equal, the installation can be run.

Both the first and the second software code are stored in a readable storage medium, which also contains the software to be protected and an installation program. In addition, this storage medium cannot be copied. This is achieved by changing the second software code or hidden number each time the software is copied losing its predefined relation with the first software code. The activation code must be generated by the producer/provider specifically for every single computer where an installation is wanted to be carried out. To be able to generate an activation code that can work in a specific computer, the software producer/provider has to obtain certain hardware specific information. This implies that for every time a user purchases software to be installed in a given computer, some form of communication between producer/provider and the user has to be in place in order to exchange the necessary information. The invention hereby presented, covers this weakness, as it does not presuppose any information exchange between producers/providers and buyers/users. Therefore, since security is not based on hardware specific information (user's computer), the transaction becomes easier for all the parts involved. Easier means also more economically efficient. In addition, the described solution (U.S. Pat. No. 5,199,066) represents a quite restrictive and rigid policy where licence is granted per specific computer. This implies that a user is not allowed to freely move the bought software from one computer to another (for example when a new computer is purchased). Again, this weakness is covered by the invention hereby presented by implementing a licence policy based on the number of installations per person regardless the equipment.

The second is a security system developed by three Japanese inventors (U.S. Pat. No. 5,796,824). The Japanese solution consists in that a storage medium (for example a CD-ROM) contains a medium number (information that a user can neither read or change and that it is unique for each storage medium), encrypted licence information and encrypted electronic data (the software to be protected). The main point with this solution is that to decrypt the encrypted electronic data (to install the software), the medium number and the encrypted licence information have to correspond with each other. In practice, this means that the electronic data a storage medium contains can only be installed from an original copy. However, this system has a weakness that the invention hereby presented covers. The invention U.S. Pat. No. 5,796,824 does not provide any way to control the number of installations carried out. Despite the fact that third parts cannot make illegal copies of an original storage medium, the system allows an infinite number of installations. In other words, an authorised user has the possibility of installing and/or running the software in as many computers as he may wish. Consequently, producers/providers of electronic data only gets a liberal security model that trusts that authorised users do not install the software in computers of non-authorised users (family members, friends, etc.). This problem is solved by the invention hereby presented by implementing a counter that controls the number of installations carried out.

The third invention (U.S. Pat. No. 6,006,190) protects software against illegal copy by encrypting both the software and the installation program based on a hardware specific key (CPU-number, BIOS information or the like). When installing the software, the key is read from the computer, the software and the installation program is encrypted, the key and the encrypted programs are stored in the storage medium supplied by the provider/producer and the software is installed encrypted. The installed software will only be able to run in the computer the installation was originally carried out given that the correct hardware specific key is needed to decrypt the software every time it is loaded into memory to be run. In the same way, the installation program cannot be run in any other computer given that the storage medium now contains an installation program that can only be run in the computer with the correct hardware specific key. The invention gives also the possibility of allowing several installations by using a counter that controls the number of times a software is installed by permitting multiple encryption of the executable files. However, this invention has a weakness that makes the security system easy to fool in real life. When the storage medium is first supplied by the producer/provider, it contains a standard encryption/decryption key and executable files (the software and the installation program) encrypted with this standard key. This standard key is replaced by the hardware specific key when a user runs the installation process for the first time (but not before this point in time). This means that a user can make as many copies of the supplied storage medium as he may wish before the installation process is run for the first time. In this way, it is possible to generate an unlimited number of illegal and functional copies of a given software. All these copies contain encrypted executable files and valid standard keys to be able to run an installation process. This weakness is covered by the invention hereby presented. Given that in the present invention security in not dependent on hardware specific information, it is not possible to make illegal and functional copies of the original storage medium at any point in time.

### 1.3 DESCRIPTION OF THE INVENTION

The goal of this invention is to protect electronic data (software or any other form of electronic data) against illegal copy and/or use by non-authorised users in a flexible, effective and efficient manner.

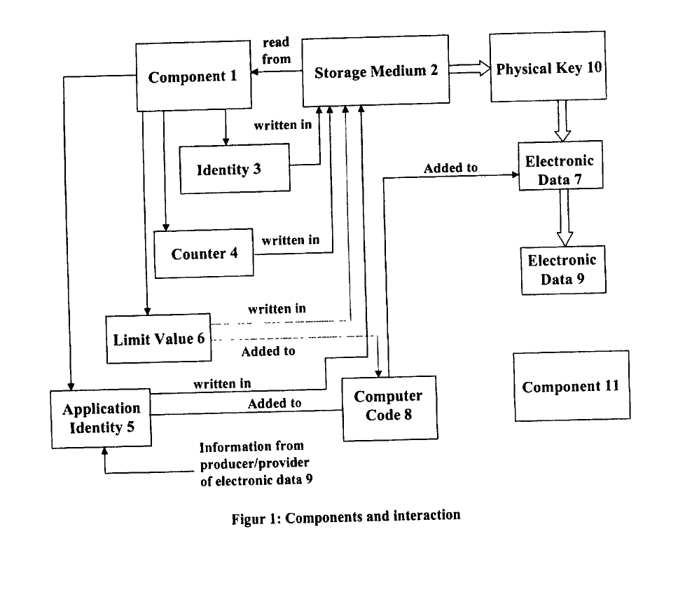

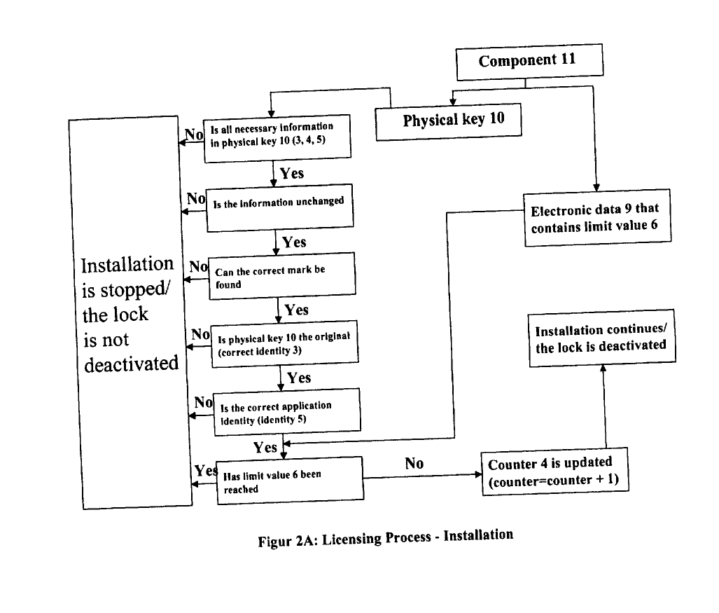

The invention consists of the following parts (see FIG. 1):

1. Electronic data 9 (a single computer program, electronic data, a package consisting of computer programs, installation programs and eventual additional installation information or a package consisting of electronic data, installation programs and eventual additional installation information) that is adapted to use the invention that is hereby presented (see claim 11, 27). Electronic data 9 may contain limit value 6 to establish a limit to the maximum number of authorised installations. Electronic data 9 contains application identity 5 (see claim 19-III, 20-III, 25-III, 26-III).

2. Physical key 10 (a computer readable/writable storage medium e.g. a floppy disk, magnetic tape, ZIP-disk, CD-R, CD-RW, mini-disk or the similar—se claim 12) that is supplied to the user together with the above-mentioned electronic data 9 with the aim of controlling that users comply with the licence agreement of electronic data 9 (see claim 19-I, 20-I, 25-I, 26-I). Physical key 10 contains counter 4 to control the number of authorised installations and other information that makes physical key 10 unique and impossible to copy. If limit value 6 is not contained by electronic data 9, limit value 6 had to be contained by physical key 10 (see claim 1, 2, 5, 6).

3. Component 11 (functionality written in any programming language) that is supplied to the user together with the above-mentioned electronic data 9. Component 11 can be compiled into the above-mentioned electronic data 9 to be installed or separated in the form of an external library file. Component 11 reads and updates the above-mentioned physical key 10 with the number of authorised installations. Component 11 can for example be a DLL-file, an ActiveX-control, an ActiveX-EXE located in a server or a class compiled into electronic data 9 (see claim 21, 22, 23, 24, 28, 29, 30).

4. Component 1 (functionality written in any programming language) that is not supplied to the user together with the above-mentioned electronic data 9. Component 1 is utilised to generate the above-mentioned physical key 10. Component 1 can be employed by an authorised producer/provider of the above-mentioned physical key 10. Component 1 can for example be a DLL-file, an ActiveX-control, an ActiveX-EXE located in a server or a class compiled into a computer program that generates physical key 10 (see claim 9, 10).

The invention that is hereby presented and that is composed by the above-mentioned parts, works as explained below:

1. Component 1 reads from storage medium 2 defined infonnation that can be used as a unique identity (identity 3) for storage medium 2 or that can be used to generate a unique identity (identity 3) for storage medium 2 through a given algorithm. The information that is read from storage medium 2 can for example be a serial number, a volume number, a volume name, the storing capacity or any other piece of information that cannot be change by a user or that can hardly be detected and changed by a user (see claim 13).

2. Identity 3 generated by component 1, is written by component 1 in a read/write-form into storage medium 2. Identity 3 can be encrypted. A read/write-form can for example be a text file or any other type of file (see claim 14). The purpose of this is to generate read/write-forms that are locked to a particular storage medium (see claim 1, 2, 5, 6). Being locked means in practice that identity 3 in the read/write-form has to correspond with identity 3 in storage medium 2 (storage medium's unique identity) for the read/write-form to be recognised as valid. This prevents read/write-forms from being moved/copied to a different storage medium. Every read/write-form in storage medium 2 and specially those containing important information (counter 4, application identity 5, eventually limit value 6) contains identity 3 to prevent read/write-forms from being moved/copied.

3. Component 1 generates a counter 4 that normally has the value zero when generating a new physical key (the start value can in practice be any value). The counter 4 is written by component 1 in storage medium 2 in a read/write-form (see claim 1, 2, 5, 6, 15). Counter 4 can be encrypted. The purpose of counter 4 is to control the number of times electronic data 9 has been installed. This can for example be done by writing counter 4 in a text file or any other type of file in an encrypted manner. At the same time, counter 4 can be written in the volume name of storage medium 2 (this is possible for most storing media as for example floppy disks, ZIP-disks, mini-disks, etc.). Writing counter 4 in two places in storage medium 2 decreases the possibility for the user to manually change counter 4 since counter 4 in the file and in the volume name have to be in its decrypted form equal. In practice, there is no limit to how many places counter 4 can be written in (one or more files, volume name, etc.).

4. Application identity 5 is generated by component 1 or supplied by the producer/provider of electronic data 9. Application identity 5 is written by component 1 in storage medium 2 in a read/write-form (see claim 1, 2, 5, 6, 16). In practice, there is no limit to how many places application identity 5 can be written in (one or more files, volume name, etc.). Application identity 5 can be encrypted. The purpose of application identity 5 is to unambiguously identify storage medium 2 with electronic data 9 so that a particular storage medium 2 can only work with the corresponding electronic data 9 (see claim 19-II, 20-II, 25-II, 26-II). This can be done in three different manners. The first is to omit application identity 5 so that storage medium 2 can work with any electronic data 9 (open modality). The second is to generate application identity 5 so that storage medium 2 can work with a given group of electronic data 9 (semi-closed modality). The third is to generate application identity 5 so that storage medium 2 can only work with a given copy of electronic data 9 (closed modality). Application identity 5 can for example be written in a text file or any other type of file in an encrypted manner. In an open modality for example, application identity 5 can be blank so that storage medium 2 can work with any computer program as for example “X”, “Y”, “Z”, etc. In a semi-closed modality, application identity 5 can be equal to “X” so that storage medium 2 can work with any copy of computer program “X”. In a closed modality, application identity 5 can be equal to “X1” so that storage medium 2 can only work with a given copy of computer program “X”, for example copy “X1”.

5. Component 1 generates a limit value 6 that represents the number of installations the producer/provider of electronic data 9 gives licence for to his users. Limit value 6 is written by component 1 in storage medium 2 in a read/write-form (see claim 2, 6, 17). In practice, there is no limit to how many places limit value 6 can be written in (one or more files, volume name. etc.). Limit value 6 can be encrypted. Limit value 6 can in practice have a value from zero to infinite. The purpose of limit value 6 is to limit the number of times electronic data 9 can be installed by a user. This can for example be done by writing limit value 6 in a text file or any other type of file in an encrypted manner. When limit value 6 is written in storage medium 2, a flexible distribution can be achieved. If we imagine that a user has for example bought a computer program with a licence for only two installations and he wants to expand his licence to five additional installations, a producer/provider can easily serve this client by generating a new physical key with a limit value equal to five. A second possibility is to write limit value 6 in electronic data 7 (source code for electronic data 9) via computer code 8 (see claim 19-III, 25-III). The problem with this approach is that flexibility is lost in relation to distribution as limit value 6 becomes hard-coded in electronic data 9 after compiling electronic data 7. If we imagine that a user has for example bought a computer program with a licence for only two installations and he wants to expand his licence to five additional installations, a producer/provider will have difficulties in serving this client as for each new physical key that is delivered, the customer obtains only licence for two additional installations. Consequently, the customer can obtain either four additional installations (two new physical keys are delivered) or six additional installations (three new physical keys are delivered). However, the advantage of this manner of writing limit value 6 is that limit value 6 becomes 100% invisible for the user.

A third alternative is to make possible for electronic data 9 to read limit value 6 from an external source (text files, INI-files, installation information or any other source). This can be done by adding certain computer code 8 to electronic data 7 (see claim 19-III, 25-III).

A fourth possibility is to combine the above-mentioned alternatives by defining limit value 6 both in storage medium 2 and through electronic data 9.

6. After that component 1 has written in storage medium 2 both counter 4, identity 3, application identity 5 and eventually limit value 6 in a read/write-form, storage medium 2 becomes physical key 10. When generating physical key 10, component 1 marks all read/write-forms physical key 10 contains (see claim 3, 4, 7, 8). The mark is done in such a way that any manual change of the read/write-forms will cause a change in the mark. This will cause the read/write-forms and therefore physical key 10 not to be recognised as valid anymore. The mark is also made in such a way that copies of read/write-forms do not get the mentioned mark and therefore lose their functionality. The mark can be accomplished by means of information written in all read/write-forms contained by physical key 10, information that users do not have the possibility to manually change or copy, or that can hardly be detected and changed by users. This information that is written in all read/write-forms contained by physical key 10, can for example be a time stamp or any other type of mark.

7. Electronic data 7 (source code for electronic data 9) have to be adapted so that electronic data 9 can work together with physical key 10. This can be done by adding certain computer code 8 into electronic data 7 so that the functionality in component 11 becomes available to or added into electronic data 9 (see point 3 in page 5). In practice, this means a few lines of code in electronic data 7. Application identity 5 has also to be added to electronic data 7 through computer code 8 by for example directly hard-coding application identity 5, making possible the reading of application identity 5 from an external source (text files, INI-files, installation information or any other source) or the like. After that computer code 8 has been added to electronic data 7, electronic data 7 is compiled. The generated electronic data 9 is then adapted to work with physical key 10 (see claim 11, 27, 19-III, 20-III, 25-III, 26-IlI).

8. The producer/provider supplies electronic data 9, physical key 10 and component 11 to a user. For the user to be able to utilised electronic data 9, a licensing process has to be started. The licensing process can be started either automatically from an installation process (the installation program in electronic data 9), manually by the user via a command (from the electronic data to be protected in electronic data 9) or whenever the producer/provider thinks it is more adequate (see claim 31, 32).

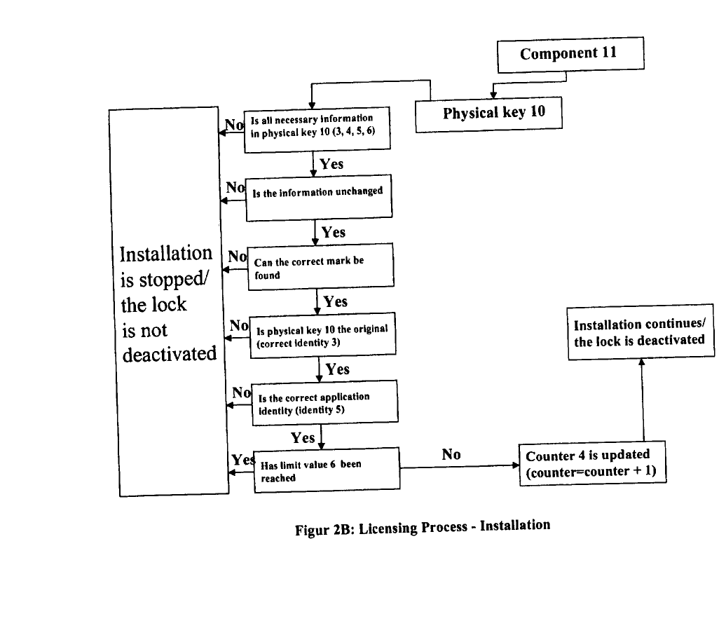

9. Under the licensing process (see FIG. 2A and 2B), component 11 starts by controlling that (see claim 19-IV to 19-IX, 20-IV to 20-IX, 25-IV to 25-IX, 26-IV to 26-IX):

a Physical key 10 contains the necessary read/write-forms (text files or any other type of files).

The information (counter 4, identity 3, application identity 5 and eventually limit value 6) located in the read/write-forms (text files or any other type of files) has not been manually changed in any way by the user. This can for example be done by writing the values several times in different places in the same or different read/write-forms and validate this values against each other.

The read/write-forms (text files or any other type of file) are the originals (not copied, not changed) by controlling the mark mentioned under point 6.

Physical key 10 is the original (the originally supplied with electronic data 9) by controlling identity 3. This is done by comparing identity 3 in all read/write-forms contained by physical key 10 with identity 3 in physical key 10 (storage medium's unique identity).

Physical key 10 corresponds with electronic data 9 by controlling application identity 5. This is done by comparing application identity 5 contained by one or several read/write-forms in the physical key 10 with application identity 5 in electronic data 9.

Limit value 6 has not yet been reached by comparing counter 4 with limit value 6.

If all above-mentioned tests pass the control, the process continues. If only one of the above-mentioned tests do not pass the control, the process stops immediately and the user will therefore not be able to utilise electronic data 9.

10. If the licensing process continues after the above-mentioned control, counter 4 is updated so that physical key 10 has control over the number of installed copies of electronic data 9 (see claim 19-X, 20-X, 25-X, 26-X). The easiest way of telling the number of installation carried out is to increment the value of counter 4 by one unit (counter=counter+1) per installation accomplished. Electronic data 9 is then in condition of being used by the user. During the update of physical key 10, the mark mentioned under point 6 may also be updated so that a new valid mark is generated each time physical key 10 is updated (see claim 19-X, 20-X, 25-X, 26-X).

11. If the licensing process is started directly from an installation process, it is sufficient that the installation process is stopped by the licensing process for the user not to be able to utilised electronic data 9 in case limit value 6 is reached or physical key 10 or its content is not valid (see point 9). If the licensing process is manually started by the user from electronic data 9 via a command (from the electronic data to be protected in electronic data 9 once the installation of electronic data 9 is completed), it is necessary to have a lock in the electronic data to be protected. The lock (see claim 33) does not make possible for the user to utilise the functionality in electronic data 9 before the licensing process is started and all tests pass the control (the control of physical key 10 as explained in point 9, the update of counter 4 as explained in point 10 and the removal of the lock). The lock can be added through computer code 8 as explained in point 7. The lock means that the user cannot use the functionality in electronic data 9 at all or that the user only has access to a reduced functionality (demo version).

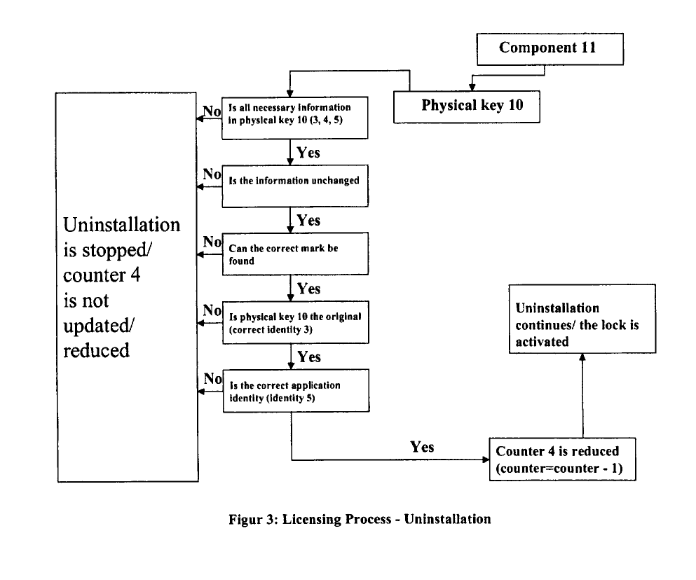

12. Under the licensing process for the uninstallation of electronic data 9 (see FIG. 3), component 11 starts by controlling that (see claim 19-XI to 19-XV, 20-XI to 20-XV, 25-XI to 25-XV, 26-XI to 26-XV):

Physical key 10 contains the necessary read/write-forms (text files or any other type of files).

The information (counter 4, identity 3, application identity 5 and eventually limit value 6) located in the read/write-forms (text files or any other type of files) has not been manually changed in any way by the user.

The read/write-forms (text files or any other type of file) are the originals (not copied, not changed) by controlling the mark mentioned under point 6.

Physical key 10 is the original (the originally supplied with electronic data 9) by controlling identity 3. This is done by comparing identity 3 in all read/write-forms contained by physical key 10 with identity 3 in physical key 10 (storage medium's unique identity).

Physical key 10 corresponds with electronic data 9 by controlling application identity 5. This is done by comparing application identity 5 contained by one or several read/write-forms in the physical key 10 with application identity 5 in electronic data 9.

If all above-mentioned tests pass the control, the process continues. If only one of the above-mentioned tests do not pass the control, the process stops immediately and the user will therefore not be able to reduce counter 4 when uninstalling electronic data 9.

13. If the licensing process for uninstalling electronic data 9 continues after the above-mentioned control, counter 4 is reduced so that physical key 10 has control over the number of installed copies of electronic data 9 (see claim 19-XVI, 20-XVI, 25-XVI, 26-XVI). The easiest way of doing this is to reduce the value of counter 4 by one unit (counter=counter−1) per installation accomplished. During the update of physical key 10, the mark mentioned under point 6 may also be updated so that a new valid mark is generated each time physical key 10 is updated (see claim 19-XVI, 20-XVI, 25-XVI, 26-XVI).

14. If the licensing process is started directly from an uninstallation process, electronic data 9 is uninstalled from the user's system. If the licensing process for uninstalling electronic data 9 is manually started by the user via a command from electronic data 9 (from the electronic data to be protected in electronic data 9), the lock (explained in point 11) in electronic data 9 is activated again (see claim 33).

The process described above results in that electronic data 9:

1. Cannot be used unless the licensing process succeeds.

2. Cannot be installed in more computers/more times than allowed by the producer/provider of electronic data 9.

3. Cannot be copied. Eventual copies are in themselves useless without a physical key that can allow additional installations.

4. In addition, physical key 10 or the information physical key 10 contains cannot be copied or changed. A copied physical key is useless. A physical key with changed content is useless (see point 6 and 9).

The method described above can be utilised to protect one or several different electronic data with the same physical key. When single electronic data or packages of electronic data that belongs together are protected, the corresponding physical key will contain a single set of information regarding the counter, the identity of the electronic data and eventually the limit value. In those cases where several different electronic data (electronic data that do not belong together because they either come from different producers/providers, represent different functionality or are independent from each other) are supplied in a package which it is wanted to be protected with only one physical key, the corresponding physical key can contain several sets (one set per electronic data) with information regarding the counter, the identity of the electronic data and eventually the limit value so that each single electronic data in the package can be administrated separately (see claim 18).

An example for how the method described above can be utilised in a real situation is presented below.

A program “X” with its respective installation system (electronic data 9) is supplied to a customer together with a disk which is the key (physical key 10) to the installation. The disk contains in an encrypted file (read/write-form) information regarding the number of installations carried out (counter 4 which for this new key has the value zero-0), the disk's serial number (identity 3), which program the disk belongs to (application identity 5) and the maximum number of installations allowed (limit value 6 which for this particular key has the value one-1). When installing program “X”, the user is asked to insert the disk in the corresponding driver (normally driver A:). Once this is done, the installation process continues and the counter in the disk is updated (its value becomes one-1). If the user tries to install program “X” in another computer, the user is asked to insert the disk in the corresponding driver (normally driver A:). Once this is done, the user gets a message informing him that he is not allowed to carry out additional installations (the value for the maximum number of installations allowed and the number of installations carried out are equal). When the user uninstall program “X”, the user is asked to insert the disk in the corresponding driver (normally driver A:). Once this is done, the installation process continues and the counter in the disk is updated (its value becomes zero-0). Now, the user can install program “X” one more time in the same computer or in a different one.

1. A method for generating a physical key for use with computers with the aim of avoiding illegal use or copy of electronic data, said physical key is a computer readable/writable storage medium with a storage medium identity that cannot be changed or that can hardly be detected and changed by users, said storage medium contains also a counter that registers the number of times the electronic data to be protected is installed and an identity to identify the electronic data to be protected, said method comprising the lock of the counter and the identity of the electronic data to a specific storage medium by utilising the storage medium identity to create a unique and unambiguous relation between the counter, the identity of the electronic data and the storage medium.

2. A method for generating a physical key for use with computers with the aim of avoiding illegal use or copy of electronic data, said physical key is a computer readable/writable storage medium with a storage medium identity that cannot be changed or that can hardly be detected and changed by users, said storage medium contains also a counter that registers the number of times the electronic data to be protected is installed, an identity to identify the electronic data to be protected and a limit value to establish the maximum number of times the electronic data can be installed, said method comprising the lock of the counter, the identity of the electronic data and the limit value to a specific storage medium by utilising the storage medium identity to create a unique and unambiguous relation between the counter, the identity of the electronic data, the limit value and the storage medium.

3. The method as claimed in claim 1 wherein the counter and the identity of the electronic data in the storage medium are marked with a time stamp or another mark. If the counter and/or the identity of the electronic data are copied to another storage medium and/or are changed, the mark of the copied/changed counter and/or identity of the electronic data is changed to an invalid value.

4. The method as claimed in claim 2 wherein the counter, the identity of the electronic data and the limit value in the storage medium are marked with a time stamp or another mark. If the counter, the identity of the electronic data and/or limit value are copied to another storage medium and/or are changed, the mark of the copied/changed counter, identity of the electronic data and/or limit value is changed to an invalid value.

5. A system for generating a physical key for use with computers with the aim of avoiding illegal use or copy of electronic data, said physical key is a computer readable/writable storage medium with a storage medium identity that cannot be changed or that can hardly be detected and changed by users, said storage medium contains also a counter that registers the number of times the electronic data to be protected is installed and an identity to identify the electronic data to be protected, said method comprising the lock of file or files containing the counter and the identity of the electronic data to a specific storage medium by writing the storage medium identity in this/these files.

6. A system for generating a physical key for use with computers with the aim of avoiding illegal use or copy of electronic data, said physical key is a computer readable/writable storage medium with a storage medium identity that cannot be changed or that can hardly be detected and changed by users, said storage medium contains also a counter that registers the number of times the electronic data to be protected is installed, an identity to identify the electronic data to be protected and a limit value to establish the maximum number of times the electronic data can be installed, said method comprising the lock of file or files containing the counter, the identity of the electronic data and limit value to a specific storage medium by writing the storage medium identity in this/these files.

7. The system as claimed in claim 5 and 6 wherein the file/files containing the identity of the storage medium, the counter, the identity of the electronic data to be protected and eventually the limit value, are marked with a given time stamp or another mark. If this/these files are changed, the time stamp or the utilised mark of the changed file/files is changed to an invalid value rendering the storage medium containing the changed file/files useless as physical key.

8. The system as claimed in claim 5 and 6 wherein the file/files containing the identity of the storage medium, the counter, the identity of the electronic data to be protected and eventually the limit value, are marked with a given time stamp or another mark. If this/these files are copied, the time stamp or the utilised mark of the copied file/files is changed to an invalid value rendering the storage medium containing the copied file/files useless as physical key.

9. The system as claimed in claim 5 and 6 wherein the copy, the mark and the lock of files in the storage medium is carried out by a component that can either be a DLL-file, an ActiveX-control or an ActiveX-EXE placed in a server.

10. The system as claimed in claim 5 and 6 wherein the copy, the mark and the lock of files in the storage medium is carried out by a component that is a class compiled in a computer program that generates physical keys.

11. The system as claimed in claim 5 and 6 wherein the electronic data is a computer program or any other type of electronic data or a package of computer programs or any other types of electronic data and an installation program with eventual additional installation information in the form of text files, INI-files or the like.

12. The system as claimed in claim 5 and 6 wherein the storage medium (the physical key) is either a floppy disk, a magnetic tape, a ZIP-disk, a CD-R, a CD-RW, a mini-disk or the like.

13. The system as claimed in claim 5 and 6 wherein the identity of the storage medium is the serial number of the storage medium, the volume serial number of the storage medium, the volume name of the storage medium, the storage capacity of the storage medium or a combination of the above-mentioned characteristics. This identity is also the identity of the physical key.

14. The system as claimed in claim 5 and 6 wherein the identity of the storage medium (the physical key) is written in the storage medium (the physical key) in the form of an encrypted or a clear string in a text file, INI-file or any other type of file.

15. The system as claimed in claim 5 and 6 wherein the counter that registers the number of times the electronic data is installed is an encrypted or a clear string in a text file, INI-file or any other type of file, an encrypted or a clear string in the volume name of the storage medium or a combination.

16. The system as claimed in claim 5 and 6 wherein the identity to identify the electronic data to be protected is an encrypted or a clear string in a text file, INI-file or any other type of file, an encrypted or a clear string in the volume name of the storage medium or a combination.

17. The system as claimed in claim 5 and 6 wherein the limit value to establish the maximum number of times the electronic data ca be installed is an encrypted or a clear string in a text file, INI-file or any other type of file, an encrypted or a clear string in the volume name of the storage medium or a combination.

18. The system as claimed in claim 5 and 6 wherein the file/files contain the counter, the identity of the electronic data and eventually the limit value of several different electronic data to be protected with the same storage medium (physical key).

19. A method for protecting electronic data against illegal use or copy that utilises a counter that registers the number of times the electronic data to be protected is installed, said method comprising
I. The utilisation of a physical key as described in claim 1, said physical key supplied by a producer/provider of electronic data, for controlling that users wanting to install electronic data with the purpose of using its functionality are holders of a valid licence or permission obtained from the respective producer/provider and that users comply with the conditions of said licence agreement.
II. The association between a physical key as described in claim 1 and a given electronic data (associated electronic data).
III. An associated electronic data that defines or contains a limit value to establish the maximum number of times said associated electronic data can be installed and an identity to identify said associated electronic data with the respective physical key. Said associated electronic data is supplied by a producer/provider together with said physical key.
IV. Controlling at the moment of installation of the supplied associated electronic data if the associated physical key contains the identity of the storage medium, a counter and the identity of the associated electronic data. Said installation process is stopped if the searched information does not exist.
V. Controlling at the moment of installation of the supplied associated electronic data if the identity of the storage medium, the counter and the identity of the associated electronic data contained by the associated physical key are not manually changed. Said installation process is stopped if the controlled information is changed.
VI. Controlling at the moment of installation of the supplied associated electronic data if the identity of the storage medium, the counter and the identity of the associated electronic data contained by the associated physical key have a valid mark. Said installation process is stopped if the controlled mark is not valid.
VII. Controlling at the moment of installation of the supplied associated electronic data if the predefined relation between the identity of the storage medium, the counter and the identity of the associated electronic data (elements contained by the associated physical key) is not changed. Said installation process is stopped if the predefined relation is not valid.
VIII. Controlling at the moment of installation of the supplied associated electronic data if the identity of the associated electronic data contained by the associated electronic data to be installed and by the associated physical key are equal. Said installation process is stopped if the compared values are not equal.
IX. Controlling at the moment of installation of the supplied associated electronic data if the counter in the associated physical key has reached the limit value defined in the associated electronic data to be installed. Said installation process is stopped if the counter is aqual or larger than the defined limit value.
X. Updating at the moment of installation of the supplied associated electronic data the counter in the associated physical key with the number of new installations. The mark in the identity of the storage medium, the counter and the identity of the associated electronic data contained by said associated physical key may eventually also be updated to a new valid value.
XI. Controlling at the moment of uninstallation of the supplied associated electronic data if the associated physical key contains the identity of the storage medium, a counter and the identity of the associated electronic data. Said uninstallation process is stopped if the searched information does not exist.
XII. Controlling at the moment of uninstallation of the supplied associated electronic data if the identity of the storage medium, the counter and the identity of the associated electronic data contained by the associated physical key are not manually changed. Said uninstallation process is stopped if the controlled information is changed.
XIII. Controlling at the moment of uninstallation of the supplied associated electronic data if the identity of the storage medium, the counter and the identity of the associated electronic data contained by the associated physical key have a valid mark. Said uninstallation process is stopped if the controlled mark is not valid.
XIV. Controlling at the moment of uninstallation of the supplied associated electronic data if the predefined relation between the identity of the storage medium, the counter and the identity of the associated electronic data (elements contained by the associated physical key) is not changed. Said uninstallation process is stopped if the predefined relation is not valid.
XV. Controlling at the moment of uninstallation of the supplied associated electronic data if the identity of the associated electronic data contained by the associated electronic data to be uninstalled and by the associated physical key are equal. Said uninstallation process is stopped if the compared values are not equal.
XVI. Reducing at the moment of uninstallation of the supplied associated electronic data the counter in the associated physical key with the number of uninstallations. The mark in the identity of the storage medium, the counter and the identity of the associated electronic data contained by said associated physical key may eventually also be updated to a new valid value.

20. A method for protecting electronic data against illegal use or copy that utilises a counter that registers the number of times the electronic data to be protected is installed, said method comprising
I. The utilisation of a physical key as described in claim 2, said physical key supplied by a producer/provider of electronic data, for controlling that users wanting to install electronic data with the purpose of using its functionality are holders of a valid licence or permission obtained from the respective producer/provider and that users comply with the conditions of said licence agreement.
II. The association between a physical key as described in claim 2 and a given electronic data (associated electronic data).
III. An associated electronic data that defines or contains an identity to identify said associated electronic data with the respective physical key. Said associated electronic data is supplied by a producer/provider together with said physical key.
IV. Controlling at the moment of installation of the supplied associated electronic data if the associated physical key contains the identity of the storage medium, a counter, the identity of the associated electronic data and a limit value. Said installation process is stopped if the searched information does not exist.
V. Controlling at the moment of installation of the supplied associated electronic data if the identity of the storage medium, the counter, the identity of the associated electronic data and the limit value contained by the associated physical key are not manually changed. Said installation process is stopped if the controlled information is changed.
VI. Controlling at the moment of installation of the supplied associated electronic data if the identity of the storage medium, the counter, the identity of the associated electronic data and the limit value contained by the associated physical key have a valid mark. Said installation process is stopped if the controlled mark is not valid.
VII. Controlling at the moment of installation of the supplied associated electronic data if the predefined relation between the identity of the storage medium, the counter, the identity of the associated electronic data and the limit value (elements contained by the associated physical key) is not changed. Said installation process is stopped if the predefined relation is not valid.
VIII. Controlling at the moment of installation of the supplied associated electronic data if the identity of the associated electronic data contained by the associated electronic data to be installed and by the associated physical key are equal. Said installation process is stopped if the compared values are not equal.
IX. Controlling at the moment of installation of the supplied associated electronic data if the counter in the associated physical key has reached the limit value defined in said associated physical key. Said installation process is stopped if the counter is aqual or larger than the defined limit value.
X. Updating at the moment of installation of the supplied associated electronic data the counter in the associated physical key with the number of new installations. The mark in the identity of the storage medium, the counter, the identity of the associated electronic data and the limit value contained by said associated physical key may eventually also be updated to a new valid value.
XI. Controlling at the moment of uninstallation of the supplied associated electronic data if the associated physical key contains the identity of the storage medium, a counter, the identity of the associated electronic data and a limit value. Said uninstallation process is stopped if the searched information does not exist.
XII. Controlling at the moment of uninstallation of the supplied associated electronic data if the identity of the storage medium, the counter, the identity of the associated electronic data and the limit value contained by the associated physical key are not manually changed. Said uninstallation process is stopped if the controlled information is changed.
XIII. Controlling at the moment of uninstallation of the supplied associated electronic data if the identity of the storage medium, the counter, the identity of the associated electronic data and the limit value contained by the associated physical key have a valid mark. Said uninstallation process is stopped if the controlled mark is not valid.
XIV. Controlling at the moment of uninstallation of the supplied associated electronic data if the predefined relation between the identity of the storage medium, the counter, the identity of the associated electronic data and the limit value (elements contained by the associated physical key) is not changed. Said uninstallation process is stopped if the predefined relation is not valid.
XV. Controlling at the moment of uninstallation of the supplied associated electronic data if the identity of the associated electronic data contained by the associated electronic data to be uninstalled and by the associated physical key are equal. Said uninstallation process is stopped if the compared values are not equal.
XVI. Reducing at the moment of uninstallation of the supplied associated electronic data the counter in the associated physical key with the number of uninstallations. The mark in the identity of the storage medium, the counter, the identity of the associated electronic data and the limit value contained by said associated physical key may eventually also be updated to a new valid value.

21. The method as claimed in claim 19 and 20 wherein the actions during the installing and uninstalling process are carried out by a component that is functionality written in any computer language.

22. The method as claimed in claim 19 and 20 wherein the actions during the installing and uninstalling process are carried out by a component that is compiled in the electronic data to be installed.

23. The method as claimed in claim 19 and 20 wherein the actions during the installing and uninstalling process are carried out by a component that is separated from the electronic data to be installed in the form of a library file.

24. The method as claimed in claim 19 and 20 wherein the actions during the installing and uninstalling process are carried out by a component that is compiled in an installation program that installs electronic data.

25. A system for protecting electronic data against illegal use or copy that utilises a counter that registers the number of times the electronic data to be protected is installed, said method comprising
I. The utilisation of a physical key as described in claim 5, said physical key supplied by a producer/provider of electronic data, for controlling that users wanting to install electronic data with the purpose of using its functionality are holders of a valid licence or permission obtained from the respective producer/provider and that users comply with the conditions of said licence agreement.
II. The association between a physical key as described in claim 5 and a given electronic data (associated electronic data).
III. An associated electronic data that defines or contains a limit value to establish the maximum number of times said associated electronic data can be installed and an identity to identify said associated electronic data with the respective physical key. Said associated electronic data is supplied by a producer/provider together with said physical key.
IV. Controlling at the moment of installation of the supplied associated electronic data if the associated physical key contains files with the identity of the storage medium, a counter and the identity of the associated electronic data. Said installation process is stopped if the searched information does not exist.
V. Controlling at the moment of installation of the supplied associated electronic data if the file/files containing the identity of the storage medium, the counter and the identity of the associated electronic data in the associated physical key are not manually changed. Said installation process is stopped if the controlled information is changed.
VI. Controlling at the moment of installation of the supplied associated electronic data if the file/files containing the identity of the storage medium, the counter and the identity of the associated electronic data in the associated physical key have a valid mark. Said installation process is stopped if the controlled mark is not valid.
VII. Controlling at the moment of installation of the supplied associated electronic data if the file/files containing the counter and the identity of the associated electronic data contain a storage medium identity that corresponds with the storage medium identity of the associated physical key that contains said file/files. Said installation process is stopped if the compared values are not equal.
VIII. Controlling at the moment of installation of the supplied associated electronic data if the identity of the associated electronic data contained by the associated electronic data to be installed and by the file/files contained by the associated physical key are equal. Said installation process is stopped if the compared values are not equal.
IX. Controlling at the moment of installation of the supplied associated electronic data if the counter in the file/files contained by the associated physical key has reached the limit value defined in the associated electronic data to be installed. Said installation process is stopped if the counter is aqual or larger than the defined limit value.
X. Updating at the moment of installation of the supplied associated electronic data the counter in the file/files contained by the associated physical key with the number of new installations. The mark in the file/files containing the identity of the storage medium, the counter and the identity of the associated electronic data in said associated physical key may eventually also be updated to a new valid value.
XI. Controlling at the moment of uninstallation of the supplied associated electronic data if the associated physical key contains files with the identity of the storage medium, a counter and the identity of the associated electronic data. Said uninstallation process is stopped if the searched information does not exist.
XII. Controlling at the moment of uninstallation of the supplied associated electronic data if the file/files containing the identity of the storage medium, the counter and the identity of the associated electronic data in the associated physical key are not manually changed. Said uninstallation process is stopped if the controlled information is changed.
XIII. Controlling at the moment of uninstallation of the supplied associated electronic data if the file/files containing the identity of the storage medium, the counter and the identity of the associated electronic data in the associated physical key have a valid mark. Said uninstallation process is stopped if the controlled mark is not valid.
XIV. Controlling at the moment of uninstallation of the supplied associated electronic data if the file/files containing the counter and the identity of the associated electronic data contain a storage medium identity that corresponds with the storage medium identity of the associated physical key that contains said file/files. Said uninstallation process is stopped if the compared values are not equal.
XV. Controlling at the moment of uninstallation of the supplied associated electronic data if the identity of the associated electronic data contained by the associated electronic data to be uninstalled and by the file/files contained by the associated physical key are equal. Said uninstallation process is stopped if the compared values are not equal.
XVI. Reducing at the moment of uninstallation of the supplied associated electronic data the counter in the file/files contained by the associated physical key with the number of uninstallations. The mark in the file/files containing the identity of the storage medium, the counter and the identity of the associated electronic data in said associated physical key may eventually also be updated to a new valid value.

26. A system for protecting electronic data against illegal use or copy that utilises a counter that registers the number of times the electronic data to be protected is installed, said method comprising
I. The utilisation of a physical key as described in claim 6, said physical key supplied by a producer/provider of electronic data, for controlling that users wanting to install electronic data with the purpose of using its functionality are holders of a valid licence or permission obtained from the respective producer/provider and that users comply with the conditions of said licence agreement.
II. The association between a physical key as described in claim 6 and a given electronic data (associated electronic data).
III. An associated electronic data that defines or contains an identity to identify said associated electronic data with the respective physical key. Said associated electronic data is supplied by a producer/provider together with said physical key.
IV. Controlling at the moment of installation of the supplied associated electronic data if the associated physical key contains files with the identity of the storage medium, a counter, the identity of the associated electronic data and a limit value. Said installation process is stopped if the searched information does not exist.
V. Controlling at the moment of installation of the supplied associated electronic data if the file/files containing the identity of the storage medium, the counter, the identity of the associated electronic data and the limit value in the associated physical key are not manually changed. Said installation process is stopped if the controlled information is changed.
VI. Controlling at the moment of installation of the supplied associated electronic data if the file/files containing the identity of the storage medium, the counter, the identity of the associated electronic data and the limit value in the associated physical key have a valid mark. Said installation process is stopped if the controlled mark is not valid.
VII. Controlling at the moment of installation of the supplied associated electronic data if the file/files containing the counter, the identity of the associated electronic data and the limit value contain a storage medium identity that corresponds with the storage medium identity of the associated physical key that contains said file/files. Said installation process is stopped if the compared values are not equal.
VIII. Controlling at the moment of installation of the supplied associated electronic data if the identity of the associated electronic data contained by the associated electronic data to be installed and by the file/files contained by the associated physical key are equal. Said installation process is stopped if the compared values are not equal.
IX. Controlling at the moment of installation of the supplied associated electronic data if the counter in the file/files contained by the associated physical key has reached the limit value defined in said file/files. Said installation process is stopped if the counter is aqual or larger than the defined limit value.
X. Updating at the moment of installation of the supplied associated electronic data the counter in the file/files contained by the associated physical key with the number of new installations. The mark in the file/files containing the identity of the storage medium, the counter, the identity of the associated electronic data and the limit value in said associated physical key may eventually also be updated to a new valid value.
XI. Controlling at the moment of uninstallation of the supplied associated electronic data if the associated physical key contains files with the identity of the storage medium, a counter, the identity of the associated electronic data and a limit value. Said uninstallation process is stopped if the searched information does not exist.
XII. Controlling at the moment of uninstallation of the supplied associated electronic data if the file/files containing the identity of the storage medium, the counter, the identity of the associated electronic data and the limit value in the associated physical key are not manually changed. Said uninstallation process is stopped if the controlled information is changed.
XIII. Controlling at the moment of uninstallation of the supplied associated electronic data if the file/files containing the identity of the storage medium, the counter, the identity of the associated electronic data and the limit value in the associated physical key have a valid mark. Said uninstallation process is stopped if the controlled mark is not valid.
XIV. Controlling at the moment of uninstallation of the supplied associated electronic data if the file/files containing the counter, the identity of the associated electronic data and the limit value contain a storage medium identity that corresponds with the storage medium identity of the associated physical key that contains said file/files. Said uninstallation process is stopped if the compared values are not equal.
XV. Controlling at the moment of uninstallation of the supplied associated electronic data if the identity of the associated electronic data contained by the associated electronic data to be uninstalled and by the file/files contained by the associated physical key are equal. Said uninstallation process is stopped if the compared values are not equal.
XVI. Reducing at the moment of uninstallation of the supplied associated electronic data the counter in the file/files contained by the associated physical key with the number of uninstallations. The mark in the file/files containing the identity of the storage medium, the counter, the identity of the associated electronic data and the limit value in said associated physical key may eventually also be updated to a new valid value.

27. The system as claimed in claim 25 and 26 wherein the electronic data is a computer program or any other type of electronic data or a package of computer programs or any other types of electronic data and an installation program with eventual additional installation information in the form of text files, INI-files or the like.

28. The system as claimed in claim 25 and 26 wherein the actions during the installing and uninstalling process are carried out by a component that is functionality written in any computer language.

29. The system as claimed in claim 25 and 26 wherein the actions during the installing and uninstalling process are carried out by a component that is a DLL-file, an ActiveX-control or an ActiveX-EXE placed in a server.

30. The system as claimed in claim 25 and 26 wherein the actions during the installing and uninstalling process are carried out by a component that is a class compiled in the electronic data to be install.

31. The system as claimed in claim 25 and 26 wherein the actions during the installing and uninstalling process are automatically started from an installation program.

32. The system as claimed in claim 25 and 26 wherein the actions during the installing and uninstalling process are manually started by the user from the electronic data or whenever the producer/provider thinks it is more adequate.

33. The system as claimed in claim 25 and 26 wherein during installation of electronic data it is written in the user's computer (for example in the form of installation files or in any other form for data registration available in the user's system) installation information necassary to run/utilise said electronic data. During uninstallation of said electronic data, said installation information is removed from the user's computer.

34. The system as claimed in claim 25 and 26 wherein the physical key is needed each time installed electronic data is run/utilised.
